(19) United States
(12) Patent Application Publication
(10) Pub. No.: US 2025/0095168 A1
(43) Pub. Date: Mar. 20, 2025

(54) GUIDED DOMAIN ADAPTATION

(71) Applicant: QUALCOMM Incorporated, San Diego, CA (US)

(72) Inventors: Julia KABALAR, München (DE); Kiran BANGALORE RAVI, Paris (FR); Nirnai ACH, Munich (DE); Mireille Lucette Laure GREGOIRE, Stuttgart (DE); Varun RAVI KUMAR, San Diego, CA (US); Senthil Kumar YOGAMANI, Headford (IE)

(21) Appl. No.: 18/468,637

(22) Filed: Sep. 15, 2023

(51) Int. Cl. G06T 7/33; G01S 17/89; G06V 20/56; G06V 20/58

(52) U.S. Cl. CPC G06T 7/33; G01S 17/89; G06V 20/58; G06V 20/588

(57) ABSTRACT

Systems and techniques are described herein for processing data. For instance, a method for processing data is provided. The method may include obtaining source features generated based on first sensor data captured using a first set of sensors; obtaining source semantic attributes related to the source features; obtaining target features generated based on second sensor data captured using a second set of sensors; obtaining map information; obtaining location information of a device comprising the second set of sensors; obtaining target semantic attributes from the map information based on the location information; aligning the target features with a set of the source features, based on the source semantic attributes and the target semantic attributes, to generate aligned target features; and processing the aligned target features to generate an output.

### TECHNICAL FIELD

The present disclosure generally relates to guided domain adaptation. For example, aspects of the present disclosure include systems and techniques for performing guided domain adaptation by determining a subset of source features and aligning target features with the subset of the source features.

### BACKGROUND

A machine-learning models can be trained to perform a task (e.g., to generate an output) based on an input. For example, a machine learning model may be trained to identify vehicles in images. During a backpropagation training process, the machine-learning model may be provided with a number of images (e.g., training data) and a number of labels associated with the images. The labels may identify vehicles within the images. The machine-learning model may attempt to identify (e.g., infer or predict) the vehicles within the images based on the images and not the labels. The predictions of the machine-learning model may be compared with the labels (e.g., the ground truth) and a difference (e.g., an error) between the predictions and the ground truth may be determined. Parameters (e.g., weights) of the machine-learning model may be adjusted to minimize the error in further rounds of the iterative training process. Once trained, the machine-learning model may be used to identify (e.g., to infer) vehicles within images based on live data (e.g., images that were not used to train the machine-learning model).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing data. According to at least one example, a method is provided for processing data. The method includes: obtaining source features generated based on first sensor data captured using a first set of sensors; obtaining source semantic attributes related to the source features; obtaining target features generated based on second sensor data captured using a second set of sensors; obtaining map information; obtaining location information of a device comprising the second set of sensors; obtaining target semantic attributes from the map information based on the location information; aligning the target features with a set of the source features, based on the source semantic attributes and the target semantic attributes, to generate aligned target features; and processing the aligned target features to generate an output.

In another example, an apparatus for processing data is provided that includes at least one memory and at least one processor (e.g., configured in circuitry) coupled to the at least one memory. The at least one processor configured to: obtain source features generated based on first sensor data captured using a first set of sensors; obtain source semantic attributes related to the source features; obtain target features generated based on second sensor data captured using a second set of sensors; obtain map information; obtain location information of a device comprising the second set of sensors; obtain target semantic attributes from the map information based on the location information; align the target features with a set of the source features, based on the source semantic attributes and the target semantic attributes, to generate aligned target features; and process the aligned target features to generate an output.

In another example, a non-transitory computer-readable medium is provided that has stored thereon instructions that, when executed by one or more processors, cause the one or more processors to: obtain source features generated based on first sensor data captured using a first set of sensors; obtain source semantic attributes related to the source features; obtain target features generated based on second sensor data captured using a second set of sensors; obtain map information; obtain location information of a device comprising the second set of sensors; obtain target semantic attributes from the map information based on the location information; align the target features with a set of the source features, based on the source semantic attributes and the target semantic attributes, to generate aligned target features; and process the aligned target features to generate an output.

In another example, an apparatus for processing data is provided. The apparatus includes: means for obtaining source features generated based on first sensor data captured using a first set of sensors; means for obtaining source semantic attributes related to the source features; means for obtaining target features generated based on second sensor data captured using a second set of sensors; means for obtaining map information; means for obtaining location information of a device comprising the second set of sensors; means for obtaining target semantic attributes from the map information based on the location information; means for aligning the target features with a set of the source features, based on the source semantic attributes and the target semantic attributes, to generate aligned target features; and means for processing the aligned target features to generate an output.

In another example, a method is provided for processing data. The method includes: obtaining source features generated based on first sensor data captured using a first set of sensors; obtaining target features generated based on second sensor data captured using a second set of sensors; determining a subset of the source features based on additional information; aligning the target features with the subset of the source features to generate aligned target features; and processing the aligned target features to generate an output.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating two vehicles each with a respective sensor suite, according to various aspects of the present disclosure;

FIG. 2 is a diagram illustrating an example system that may include one or more machine-learning model(s) trained to generate one or more output(s) based on source data, according to various aspects of the present disclosure;

FIG. 3 is a diagram illustrating an example system to illustrate first example operations of the feature extractor of FIG. 2, according to various aspects of the present disclosure;

FIG. 4 is a diagram illustrating an example system to illustrate second example operations of the feature extractor of FIG. 2, according to various aspects of the present disclosure;

FIG. 5 is a diagram illustrating an example system to illustrate third example operations of the feature extractor of FIG. 2, according to various aspects of the present disclosure;

FIG. 6 is a diagram illustrating an example system that may use machine-learning model(s) (which may be trained using source training data) to process target data, according to various aspects of the present disclosure;

FIG. 7 is a block diagram illustrating an example system to illustrate operations of the aligner of FIG. 6, according to various aspects of the present disclosure;

FIG. 8 includes an illustration of a top-down view of a scenario and a perspective view of another scenario, according to various aspects of the present disclosure;

FIG. 9 includes an image overlaid with semantic labeled regions and bounding boxes, according to various aspects of the present disclosure;

FIG. 10 is a block diagram illustrating an example system that may be used to train the aligner of FIG. 6 and FIG. 7 and/or machine-learning model(s), according to various aspects of the present disclosure;

FIG. 11 is a flow diagram illustrating another example process for performing guided domain adaptation, in accordance with aspects of the present disclosure;

FIG. 12 is a block diagram illustrating an example of a deep learning neural network that can be used to implement a perception module and/or one or more validation modules, according to some aspects of the disclosed technology;

FIG. 13 is a block diagram illustrating an example of a convolutional neural network (CNN), according to various aspects of the present disclosure; and

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, a machine-learning models can be trained (using training data) to perform a task based on live data. In some cases, the training of a machine-learning model may be related to a sensor suite used to obtain the training data (e.g., sensor data). For example, if a machine-learning model is trained using sensor data from a camera with specific intrinsic and/or extrinsic parameters, the machine-learning model may perform its task well on live data (e.g., at inference) from the camera and less well on data from one or more other cameras with other intrinsic and/or extrinsic parameters. Using training data from too few sources may result in what is referred to as overfitting. An overfit machine-learning model may produce poorer results when used on live data from a data source other than the data source which provided the training data for the machine-learning model.

However, in some cases, it may be desirable to train a machine-learning model based on limited training data. For example, for automotive tasks (e.g., vehicle identification and/or lane identification), it may be advantageous to train a machine-learning model to perform the tasks using training data captured by a sensor suite of one model of vehicle (e.g., the model of vehicle on which the machine-learning model will be deployed). As another example, there may be a large corpus of training data generated (e.g., images captured) by the sensor suite from the model of vehicle (further the large corpus of training data may be labeled).

The training of a machine-learning model may be costly (e.g., in terms of time and/or computational resources). For example, it may take hundreds of hours and thousands of pieces of training data (including labeled data which may be costly to generate) to train a machine-learning model. Thus a trained machine-learning model may be valuable.

In some situations, it may be desirable to adapt a machine-learning model trained using limited training data (e.g., training data from a single class of sensor suite) to operate using live data from a different sensor suite. Adapting a trained machine-learning model may be referred to in the art as domain adaptation.

The present disclosure describes improvements to domain adaptation. For example, the present disclosure describes systems and techniques that may cause machine-learning models adapted according to the systems and techniques to perform better than machine-learning models adapted according to other techniques.

Systems, apparatuses, methods (also referred to as processes), and computer-readable media (collectively referred to herein as “systems and techniques”) are described herein for guided domain adaptation. For example, the systems and techniques described herein may use a machine-learning model trained using training source features based on training source data. For instance, the training source data may be captured using a first set of sensors (e.g., of a device or system, such as a vehicle, an XR device, etc.). The training source features may be generated based on the training source data. The machine-learning model may be trained using the training source features.

The systems and techniques may obtain target features generated based on second sensor data captured using a second set of sensors. For instance, the second sensor data may be captured live using the second set of sensors (e.g., at inference when trained machine learning model is deployed on a vehicle is driving in an environment). The systems and techniques may generate the target features based on the second sensor data. It may be advantageous for the systems and techniques to process the target features (which may be generated live based on second sensor data from the second set of sensors) using the trained machine-learning model (which was trained using the training source features based on the first sensor data from the first set of sensors). To enable this, the systems and techniques may perform domain adaptation by aligning the target features with the source features on which the machine-learning model was trained.

According to aspects described herein, the systems and techniques may perform a guided domain adaptation by determining a subset of source features (e.g., filtering the source features) and aligning the target features with the subset of the source features. For example, the systems and techniques may obtain source features generated based on the first sensor data captured using the first set of sensors. The source features may be the training source features or the source features may be a subset of the training source features. The systems and techniques may determine a subset of the source features based on a similarity between the subset of the source features and the target features (e.g., which may be captured live). For example, the systems and techniques may compare the target features to the source features and identify the subset of the source features based on a similarity between the target features and the subset of the source features. Additionally or alternatively, the systems and techniques may obtain source semantic attributes related to the source features and target semantic attributes related to the target features and identify the subset of the source features based on a similarity between the target semantic attributes and the source semantic attributes. Additionally or alternatively, the systems and techniques may obtain source trajectory information related to the source features and target trajectory information related to the target features and identify the subset of the source features based on a similarity between the target trajectory information and the source trajectory information.

Having identified the subset of the source features, the systems and techniques may align the target features with the subset of the source features to generate aligned target features. Then the systems and techniques may process the aligned target features using the machine-learning model to generate an output or perform a task. The output generated based on the aligned target features may be more accurate than the output would be if the output were generated based on the target features or based on target features aligned according to another technique. For example, the output generated based on the aligned target features may be more accurate than the output would be if the output were generated based on target features aligned using the whole of the source features rather than the subset of the source features.

Various aspects of the application will be described with respect to the figures below.

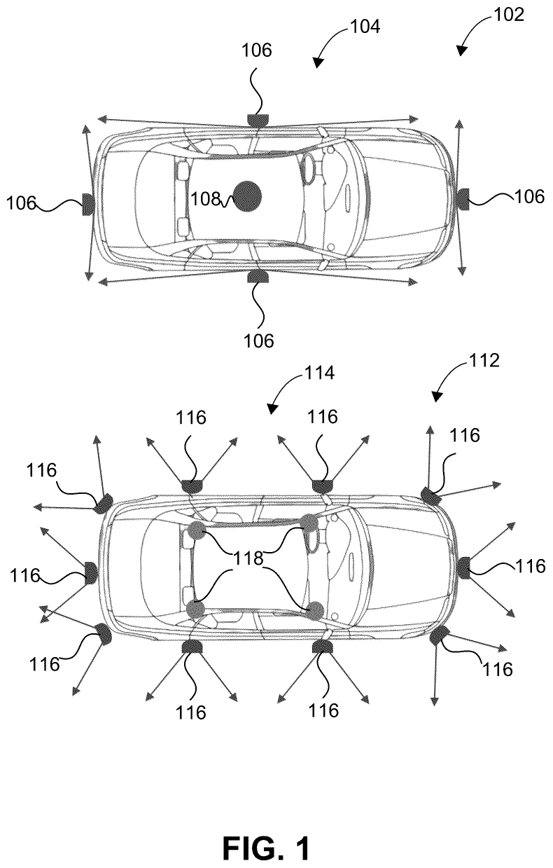

FIG. 1 is a diagram illustrating two vehicles each with a respective sensor suite, according to various aspects of the present disclosure. In particular, FIG. 1 illustrates a source vehicle 102 including a source sensor suite 104 and target vehicle 112 including a target sensor suite 114. Source sensor suite 104 includes four cameras 106 and one Light Detection and Ranging (LIDAR) sensor 108. Each of cameras 106 may be a surround view (SV) camera or a fisheye camera, for example, with a wide (e.g., nearly 180 degree) field of view. LIDAR sensor 108 may be a 64-layer LIDAR sensor. Target sensor suite 114 includes ten cameras 116 and four LIDAR sensors 118. Each of cameras 116 may be a rectilinear camera, for example, with a 90-degree field of view. LIDAR sensors 118 may be include four 16-layer LIDAR sensors.

Collectively, source sensor suite 104 may have certain intrinsic parameters (e.g., focal lengths of cameras 106, optical centers of cameras 106, skew coefficients of cameras 106, frame-capture rates of cameras 106, scan patterns of LIDAR sensor 108, and/or intensity channels of LIDAR sensor 108) and certain extrinsic parameters (e.g., positions of cameras 106 and LIDAR sensor 108 on source vehicle 102). Target sensor suite 114 may have other intrinsic parameters (e.g., focal lengths of cameras 116, optical centers of cameras 116, skew coefficients of cameras 116, frame-capture rates of cameras 116, scan patterns of LIDAR sensors 118, and/or intensity channels of LIDAR sensors 118) and other extrinsic parameters (e.g., positions of cameras 116 and LIDAR sensors 118 on target vehicle 112).

Data from source sensor suite 104 may be used to train machine-learning models to perform specific tasks such as static three dimensional (3D) and/or bird's eye view (BEV) tasks, for instance: 3D lane detection, 3D object detection (e.g., traffic-light detection, and/or sign detection), and/or static two-dimensional (2D) perspective-view (PV) tasks for instance: image-based lane detection and/or 2D object detection and/or other tasks. The systems and techniques may adapt the machine-learning models for deployment on target vehicle 112. For example, the systems and techniques may adapt the machine-learning models trained based on training data from source sensor suite 104 to operate on live data from target sensor suite 114. The machine-learning models may then be used in the operation of target vehicle 112.

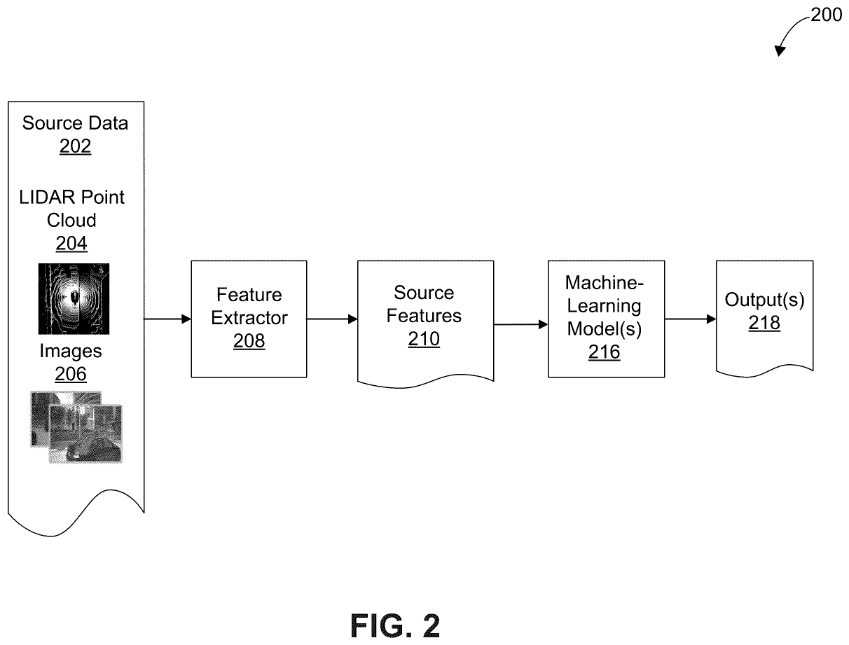

FIG. 2 is a diagram illustrating an example system 200 that may include one or more machine-learning model(s) 216 trained to generate one or more output(s) 218 based on source data 202, according to various aspects of the present disclosure. Source data 202 may include one or more LIDAR point clouds 204 (e.g., captured by a LIDAR sensor, such as LIDAR sensor 108 of FIG. 1) and images 206 (e.g., captured by one or more cameras, such as cameras 106 of FIG. 1). A feature extractor 208 of system 200 may generate source features 210 based on source data 202. System 200 may provide source features 210 to machine-learning model(s) 216. Machine-learning model(s) 216 may generate output(s) 218 based on source features 210.

Machine-learning model(s) 216 and/or feature extractor 208 may be trained using source data (e.g., data from a sensor suite of a “source” vehicle, such as source sensor suite 104 of source vehicle 102). In the present disclosure, the term “source” may refer to one source of data and the term “target” may refer to another source of data. In the present disclosure, in general, machine-learning models may be trained using source data (which may be captured using a sensor suite of a source vehicle). Further, machine-learning models may be adapted to perform tasks, for example, at inference, using target data (which may be captured using a sensor suite of a target vehicle).

System 200 may be an illustration of machine-learning model(s) 216 operating at an inference stage of operation, for example, processing live source data 202 to generate output(s) 218. Machine-learning model(s) 216 and/or feature extractor 208 of system 200 may be trained during a training phase of operation. For example, training source data (e.g., a corpus of source data 202) may be processed by feature extractor 208 and machine-learning model(s) 216 and system 200 may generate outputs. The outputs may be compared with ground truth data and an error may be determined between the performance of system 200 (e.g., the outputs) and the ground truth data. Machine-learning model(s) 216 and/or feature extractor 208 may be adjusted, for example, parameters (e.g., weights) of machine-learning model(s) 216 and/or feature extractor 208 may be adjusted based to decrease the error in further iterations of the training phase of operations.

Machine-learning model(s) 216 may include any number of related or independent machine-learning models. Machine-learning model(s) 216 may perform tasks related to, for example, object detection and lane detection. Machine-learning model(s) 216 may perform tasks using two-dimensional (2D) techniques and/or three-dimensional (3D) techniques. Machine-learning model(s) 216 may perform tasks which may involve generating output(s) 218. Output(s) 218 may include data (e.g., locations of vehicles or lanes), signals, and/or instructions to other modules.

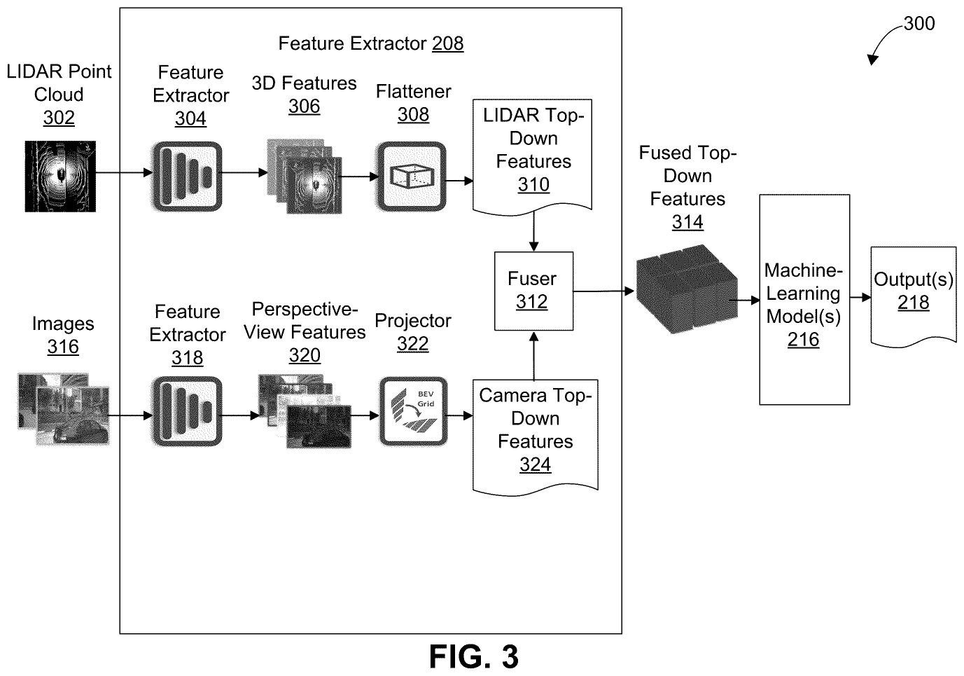

FIG. 3 is a diagram illustrating an example system 300 to illustrate first example operations of feature extractor 208, according to various aspects of the present disclosure. In general, feature extractor 208 may extract features from LIDAR point cloud 302 and images 316 to generate fused top-down features 314.

Feature extractor 208 may operate in the same way, or substantially the same way, regardless of whether feature extractor 208 operates on source data or target data. Thus, LIDAR point cloud 302 may be captured by any suitable LIDAR sensor or group of sensors (e.g., LIDAR sensor 108 or LIDAR sensors 118). Also, images 316 may be captured by any suitable camera or group of cameras (e.g., cameras 106 or cameras 116).

Feature extractor 208 includes a feature extractor 304 which may generate 3D features 306 based on LIDAR point cloud 302. Feature extractor 304 may be, or may include, a trained encoder machine-learning model (e.g., a neural network trained to encode LIDAR point cloud data into features). 3D features 306, being based on three-dimensional LIDAR point cloud 302, may be three-dimensional. 3D features 306 may be sparse, for example, 3D features 306 may include many zero values. Flattener 308 may flatten 3D features 306 (which may be three-dimensional) to generate LIDAR top-down features 310, which may be two-dimensional according to a top-down view or bird's eye view (BEV).

Feature extractor 208 includes a feature extractor 318 which may generate perspective-view features 320 based on images 316. Feature extractor 318 may be, or may include, a trained encoder machine-learning model (e.g., a neural network trained to encode image data into features). Perspective-view features 320, being based on two-dimensional images 316, may be two-dimensional. Further, perspective-view features 320 may be related to a perspective view (e.g., the perspective of the cameras which capture images 316). Projector 322 may project perspective-view features 320 to generate camera top-down features 324, which may be two-dimensional according to a top-down view.

Feature extractor 208 includes a fuser 312 which may fuse LIDAR top-down features 310 and camera top-down features 324 to generate fused top-down features 314. Fused top-down features 314 may be, or may include, features based on LIDAR top-down features 310 and camera top-down features 324. Fused top-down features 314 may be two-dimensional according to a top-down view.

Machine-learning model(s) 216 may generate output(s) 218 based on fused top-down features 314. Machine-learning model(s) 216 may perform tasks related to, for example, lane detection and object detection. Machine-learning model(s) 216 may perform the task using 3D techniques and/or 2D techniques (e.g., based on fused top-down features 314). Output(s) 218 may be the result of performing the tasks.

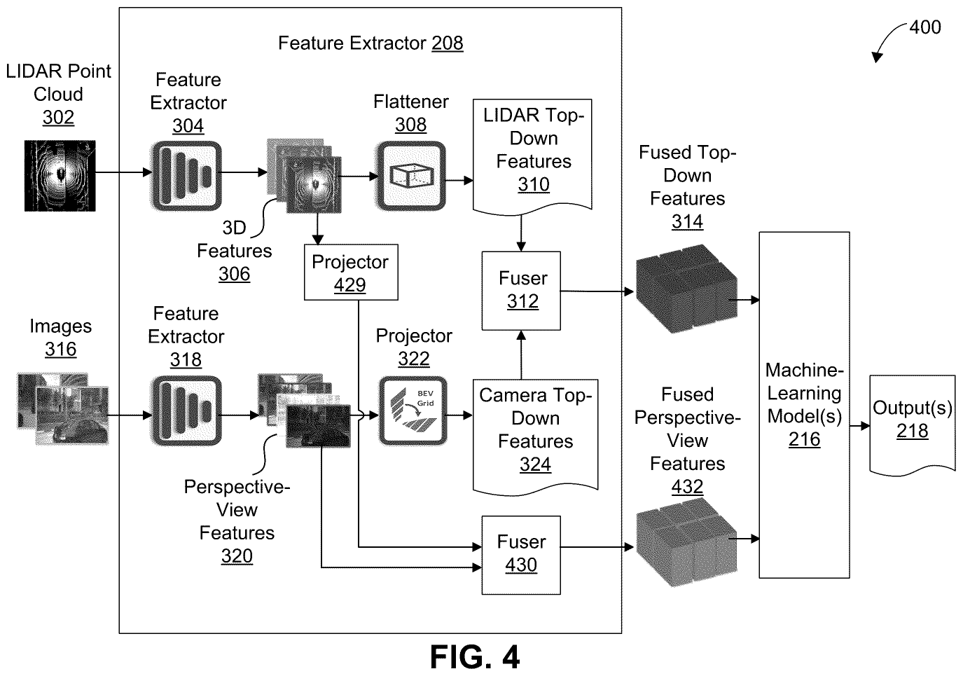

FIG. 4 is a diagram illustrating an example system 400 to illustrate second example operations of feature extractor 208, according to various aspects of the present disclosure. In general, feature extractor 208 may extract features from LIDAR point cloud 302 and images 316 to generate fused top-down features 314 and fused perspective-view features 432.

In addition to the first operations described with regard to FIG. 3, feature extractor 208 includes a projector 429 that may project 3D features 306 (e.g., from a top-down view into a perspective view) and a fuser 430 which may fuse the projected 3D features 306 and perspective-view features 320 to generate fused perspective-view features 432. Fused perspective-view features 432 may be, or may include, features based on 3D features 306 and perspective-view features 320. Fused perspective-view features 432 may be two-dimensional according to a perspective view.

Machine-learning model(s) 216 may generate output(s) 218 based on fused top-down features 314 and fused perspective-view features 432. Machine-learning model(s) 216 may perform tasks related to, for example, lane detection and object detection. Machine-learning model(s) 216 may perform the task using 3D techniques and/or 2D techniques (e.g., based on fused top-down features 314 and fused perspective-view features 432). Output(s) 218 may be the result of performing the tasks.

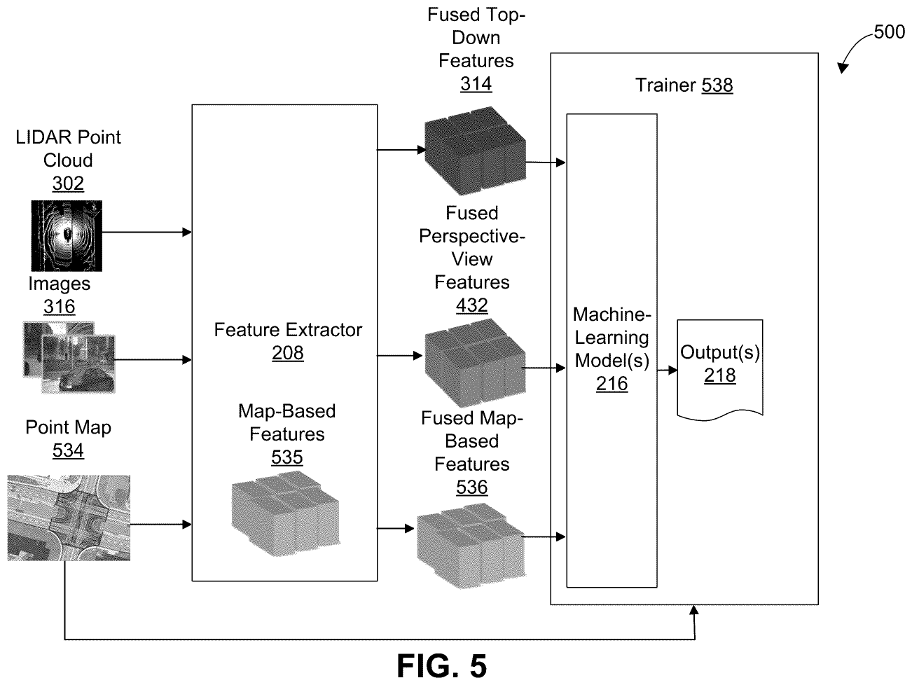

FIG. 5 is a diagram illustrating an example system 500 to illustrate third example operations of feature extractor 208, according to various aspects of the present disclosure. For example, as described with regard to FIG. 2, FIG. 3, and FIG. 4, feature extractor 208 may generate fused top-down features 314 and fused perspective-view features 432 based on LIDAR point cloud 302 and images 316, feature extractor 208. Additionally, feature extractor 208 may generate map-based features 535 based on point map 534, LIDAR point cloud 302, and/or images 316. For instance, feature extractor 208 may extract map-based features 535 from point map 534. Map-based features 535 may be another source of static perception/objects. Additionally or alternatively, map-based features 535 (and/or map 534) may be be used as an additional source of ground truth information for training (e.g., of machine-learning model(s) 216). Feature extractor 208 may generate map-based features 535 based on point map 534 (e.g., using a decoder machine-learning model, such as a decoder neural network). Further, in some aspects, feature extractor 208 may fuse map-based features 535 with features based on LIDAR point cloud 302 and/or images 316 (e.g., using a fuser similar to fuser 312 and/or fuser 326) to generate map-based features 536.

Additionally, according to some aspects, machine-learning model(s) 216 may be trained, at least in part, based on map-based features 535, point map 534, and/or map-based features 536. For example, data of map-based features 535, point map 534, and/or map-based features 536 may be provided as ground truth for training of machine-learning model(s) 216, for example, by a trainer 538.

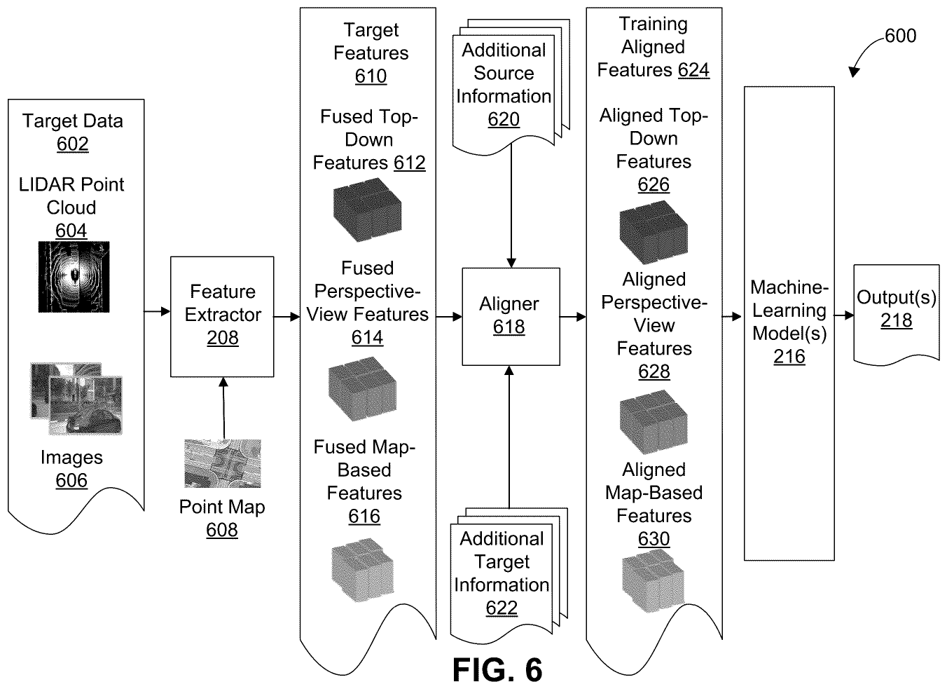

FIG. 6 is a diagram illustrating an example system 600 that may use machine-learning model(s) 216 (which may be trained using source training data) to process target data 602, according to various aspects of the present disclosure. For example, system 600 includes aligner 618 that may align target features 610 with source features to generate training aligned features 624. Machine-learning model(s) 216 may process training aligned features 624 to generate output(s) 218.

Target data 602 may include one or more LIDAR point clouds 604 (e.g., captured by a LIDAR sensor, such as LIDAR sensors 118 of FIG. 1) and images 606 (e.g., captured by one or more cameras, such as cameras 116 of FIG. 1). Target data 602 may be captured by sensors of a sensor suite that is different from the sensor suite that captured the training data on which machine-learning model(s) 216 was trained. Additionally, target data 602 may include location information that may be correlated to points on point map 608. Target data 602 may be live data, for example, data captured by target sensor suite 114 of target vehicle 112 as target vehicle 112 is in operation. Output(s) 218 of machine-learning model(s) 216 may be used by target vehicle 112 to operate target vehicle 112.

Feature extractor 208 may generate target features 610 based on target data 602 and point map 608. As mentioned above, feature extractor 208 may operate in substantially the same way regardless of the source of the data provided as an input. As such, fused top-down features 612 may be an example of fused top-down features 314, fused perspective-view features 614 may be an example of fused perspective-view features 432, and fused map-based features 616 may be an example of map-based features 536.

Aligner 618 may adapt or align target features 610 to generate training aligned features 624 (which may include aligned top-down features 626, aligned perspective-view features 628, and aligned map-based features 630). Thus, aligner 618 may perform domain alignment in both perspective view jointly with BEV view. Aligner 618 may adapt target features 610 through a guided domain adaptation. Training aligned features 624 may be such that machine-learning model(s) 216 (which was trained on source data) may process training aligned features 624 to generate output(s) 218. Machine-learning model(s) 216 may perform the same, or substantially the same operations when provided with source features 210 as when provided with training aligned features 624. Aligner 618 may align training aligned features 624 such that machine-learning model(s) 216 is enabled to perform the same, or substantially the same, operations on training aligned features 624 as on source features 210. Yet, output(s) 218, generated based on training aligned features 624 (as generated by aligner 618), may be more accurate than if output(s) 218 were generated based on features aligned according to another technique.

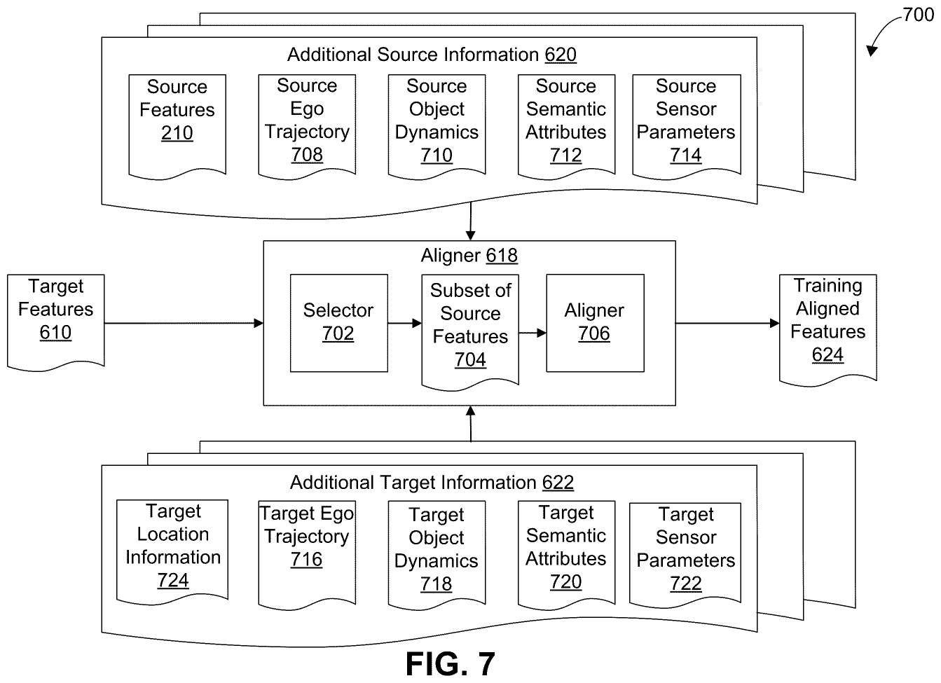

Aligner 618 may adapt target features 610 based on additional source information 620 and additional target information 622. Additional detail regarding additional source information 620, additional target information 622, and aligner 618 are provided with regard to FIG. 7.

FIG. 7 is a block diagram illustrating an example system 700 to illustrate operations of aligner 618, according to various aspects of the present disclosure. In general, aligner 618 may obtain source features 210, select a subset 704 of source features 210, and align target features 610 based on subset 704 of source features 210 to generate training aligned features 624. More specifically, aligner 618 may include a selector 702 which may obtain source features 210 and select subset 704 of source features 210 based on target features 610, additional source information 620, and additional target information 622. Aligner 618 further includes an aligner 706 that may generate training aligned features 624 based on target features 610 and subset 704 of source features 210. For example, aligner 706 may align target features 610 based on subset 704 of source features 210.

Source features 210 may be, or may include, features generated based on source data (e.g., data captured by a source sensor suite, such as source sensor suite 104 of FIG. 1). The source data may be processed by feature extractor 208 to generate source features 210. Source features 210 may be, or may include, the training data used to train machine-learning model(s) 216. Alternatively, source features 210 may be a subset of the training data used to train machine-learning model(s) 216. Additionally or alternatively, source features 210 may include data substantially similar to the data used to train machine-learning model(s) 216 (e.g., data captured by the same class of sensor suite as the data used to train machine-learning model(s) 216).

In some aspects, when deployed (e.g., on target vehicle 112), system 700 may include additional source information 620, including source features 210. For example, target vehicle 112 may include data storage to store additional source information 620, including source features 210 (e.g., including features based on source data on which machine-learning model(s) 216 was trained). In some aspects, when deployed, some elements of system 700 may be deployed at, or on, target vehicle 112 and other elements may be remote from target vehicle 112. For example, additional source information 620 may be stored remote from target vehicle 112 and target vehicle 112 may receive portions of additional source information 620 as needed. As another example, aligner 618 and additional source information 620 may be remote from target vehicle 112. In such aspects target vehicle 112 may generate target features 610 and additional target information 622 and provide target features 610 and additional target information 622 to aligner 618 (which may be remote from target vehicle 112) aligner 618 may store additional source information 620 and may generate training aligned features 624 based on target features 610, additional target information 622, and additional source information 620, and provide training aligned features 624 to target vehicle 112.

Selector 702 may obtain target features 610 which may be, or may include, features generated based on target data (e.g., data captured by a target sensor suite, such as target sensor suite 114 of FIG. 1). The target sensor suite may be different than the source sensor suite (e.g., the sensor suite that provided the data on which machine-learning model(s) 216 was trained). The target data may be processed by feature extractor 208 to generate target features 610. In some cases, the target data may be live (e.g., captured by an operating sensor suite of an operational vehicle that may expect output(s) 218).

Selector 702 may select subset 704 of source features 210 based on a similarity between target features 610 and subset 704 of source features 210. In some cases, the similarity may be determined based on target features 610 and subset 704 of source features 210. In such cases, for example, selector 702 may directly compare target features 610 to source features 210 and identify subset 704 of source features 210 based on the similarity between subset 704 of source features 210 and target features 610. For example, selector 702 may measure a mean perspective view and/or BEV feature map difference.

Additionally or alternatively, in some cases, selector 702 may compare source perception data (e.g., the data on which source features 210 is based) and target perception data (e.g., the data on which target features 610 is based). In such cases, selector 702 may determine portions of source perception data that is similar to the target perception data.

Additionally or alternatively, the similarity may be determined based on additional source information 620 related to subset 704 of source features 210 and additional target information 622 related to target features 610. For example, selector 702 may directly compare elements of additional source information 620 with elements of additional target information 622. Additionally or alternatively, the similarity may be determined based on output(s) 218 of machine-learning model(s) 216. For example, selector 702 may process subset 704 of source features 210 and training aligned features 624 using machine-learning model(s) 216 to generate respective output(s) 218 and compare the respective outputs.

As an example, source ego trajectory 708 may be, or may include, trajectory information related to source features 210. More specifically, source ego trajectory 708 may be, or may include, trajectory information generated by source vehicle 102 (e.g., using location services, accelerometers, and/or other sensors). Further, source ego trajectory 708 may be correlated with source features 210. For example, source vehicle 102 may have generated source ego trajectory 708 and the sensor data on which source features 210 is based at substantially the same time such that source ego trajectory 708 may describe the trajectory of source vehicle 102 while source sensor suite 104 of source vehicle 102 captured the source data on which source features 210 is based.

Similarly, target vehicle 112 may generate target ego trajectory 716, which may describe a trajectory of target vehicle 112 using location services, accelerometers, and/or other sensors. Target vehicle 112 may capture the target sensor data on which target features 610 is based and target ego trajectory 716 at the same time such that target ego trajectory 716 may correlate with target features 610.

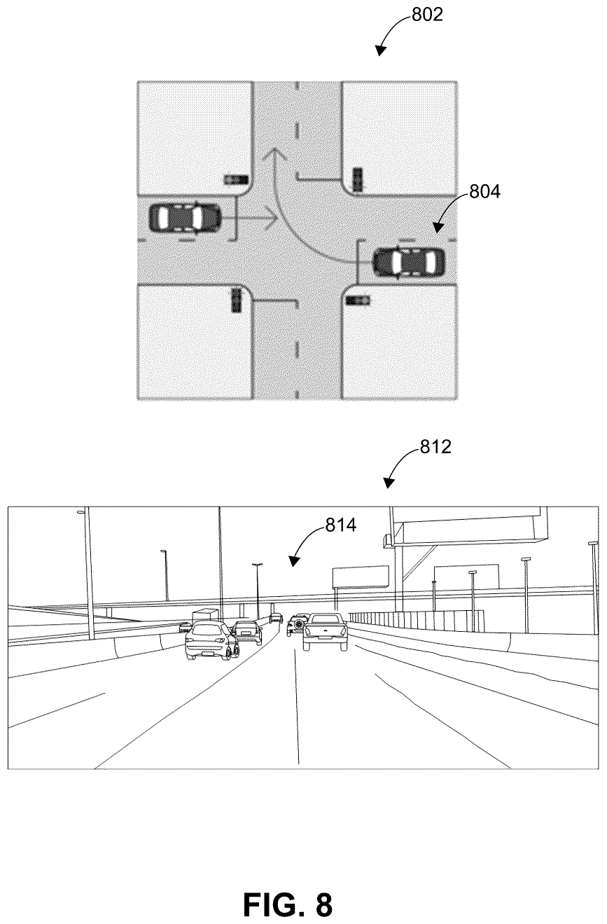

Selector 702 may compare source ego trajectory 708 with target ego trajectory 716 and may identify subset 704 of source features 210 based on a similarity between target ego trajectory 716 and source ego trajectory 708. One practical result of selecting subset 704 of source features 210 based on a comparison between source ego trajectory 708 and target ego trajectory 716 is that subset 704 of source features 210 may be based on source sensor data captured under trajectory conditions similar to the trajectory conditions under which the target sensor data on which target features 610 is based were captured. As such subset 704 of source features 210 may be more similar to target features 610 than source features 210 generally are to target features 610. The term “trajectory conditions” may refer to how the sensor suite which captured the data is moving. For example, the trajectory conditions (e.g., speed, acceleration, and/or turning) of a vehicle traveling through an intersection may be different than the trajectory conditions of a vehicle traveling on a highway. For example, FIG. 8 includes an illustration of a top-down view 802 of a scenario 804 and a perspective view 812 of a scenario 814. The trajectory of an ego-vehicle (e.g., either of the vehicles illustrated in top-down view 802) in scenario 804 may be different from the trajectory of an ego vehicle (e.g., the vehicle which captured an image on which perspective view 812 is based) of scenario 814.

Returning to FIG. 7, as another example, source object dynamics 710 may be, or may include, location (and/or movement) information related to objects detected by source vehicle 102 based on source sensor data captured by source sensor suite 104. For example, source vehicle 102 may track objects (e.g., other vehicles, pedestrians, and animals) based on source sensor data captured by source sensor suite 104 (e.g., LIDAR point cloud 204 and/or images 206). Source object dynamics 710 may be, or may include, such information. Source object dynamics 710 may be correlated with source features 210. For example, the same source sensor data may be used to generate source object dynamics 710 and source features 210.

Similarly, target vehicle 112 may detect and/or track objects based on target sensor data from target sensor suite 114. Target vehicle 112 may store detection and/or tracking information as target object dynamics 718. Target object dynamics 718 may describe dynamics of objects surrounding target vehicle 112. The same target sensor data may be used to generate target features 610 and target ego trajectory 716. As such, target features 610 and target ego trajectory 716 may be correlated.

Selector 702 may compare source object dynamics 710 with target object dynamics 718 and may identify subset 704 of source features 210 based on a similarity between source object dynamics 710 and target object dynamics 718. One practical result of selecting subset 704 of source features 210 based on a comparison between source object dynamics 710 and target object dynamics 718 is that subset 704 of source features 210 may be based on source sensor data captured under surrounding-object conditions similar to the surrounding-object conditions under which the target sensor data on which target features 610 is based were captured. As such subset 704 of source features 210 may be more similar to target features 610 than source features 210 generally are to target features 610. The term “surrounding-object conditions” may refer to dynamics of objects around the sensor suite which captured the data. For example, the surrounding-object conditions may include motion of other vehicles, motion of pedestrians, and/or motion of animals. The surrounding-object conditions (e.g., motion of other vehicles) of a vehicle traveling through an intersection may be different than the surrounding-object conditions of a vehicle traveling on a highway. For example, returning to FIG. 8, the trajectories of other vehicles (e.g., either of the vehicles illustrated in top-down view 802) in scenario 804 may be different from the trajectory other vehicles (e.g., any of the vehicles represented in perspective view 812) of scenario 814.

Returning to FIG. 7, as another example, source semantic attributes 712 may include semantic information (e.g., semantic labels and/or semantically labeled images) related to source features 210. For example, in one case, a semantic labeling machine-learning model (or a person) may label source data (e.g., images 206). Source semantic attributes 712 may include such labels or features based on such labels. As another example, source semantic attributes 712 may be determined based on a map. For example, source features 210 may be correlated with a point map. A point map (e.g., a high-definition (HD) map) may include three-dimensional data (e.g., elevation data) regarding a three-dimensional space, such as a road on which a vehicle is navigating. For instance, the point map can include a plurality of map points corresponding to one or more reference locations in the three-dimensional space. In some cases, the point map can include dimensional information for objects in the three-dimensional space and other semantic information associated with the three-dimensional space. For instance, the information from the point map can include elevation or height information (e.g., road elevation/height), normal information (e.g., road normal), and/or other semantic information related to a portion (e.g., the road) of the three-dimensional space in which the vehicle is navigating.

In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

The source data on which source features 210 is based may be correlated with a point map. Source semantic attributes 712 may be derived from the point map. For example, semantic labels may be extracted from the point map and included in source semantic attributes 712 in relation to source features 210. For example, the source vehicle may be localized within an HD map and references to static map attribute layers around the source vehicle may be obtained.

Similarly, target vehicle 112 may have location information and a point map. Target semantic attributes 720 may include semantic labels extracted from the point map based on the location of target vehicle 112. For example, target semantic attributes 720 may include semantic labels of locations around target vehicle 112 while target vehicle 112 captures the target data on which target features 610 is based. For example, the target vehicle may be localized within an HD map and references to static map attribute layers around the target vehicle may be obtained. Obtaining semantic attributes results in a relatively inexpensive (in terms of cost and/or computation time) source for semantic annotation which can be used for guided domain adaptation.

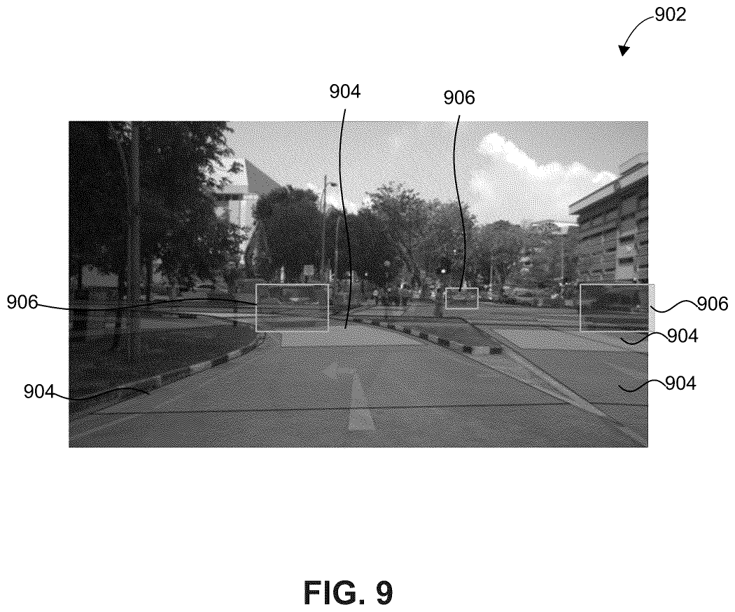

Selector 702 may compare source semantic attributes 712 with target semantic attributes 720 and may identify subset 704 of source features 210 based on a similarity between source semantic attributes 712 and target semantic attributes 720. One practical result of selecting subset 704 of source features 210 based on a comparison between source semantic attributes 712 and target semantic attributes 720 is that subset 704 of source features 210 may be based on source sensor data captured in an environment similar to the environment in which the target sensor data on which target features 610 is based is captured. As such subset 704 of source features 210 may be more similar to target features 610 than source features 210 generally are to target features 610. The semantic labels of source semantic attributes 712 may describe the environment of source vehicle 102 while source vehicle 102 captured the source data on which source features 210 is based. Similarly, target semantic attributes 720 may describe the environment of target vehicle 112 while target vehicle 112 captures the target data on which target features 610 is based. The source semantic attributes 712 and target semantic attributes 720 may include labels such as, for example, road, sidewalk, shoulder, crosswalk, intersection, tree, building, driveway, and dirt road. The environment of a vehicle traveling through an intersection may be different than the environment of a vehicle traveling on a highway. For example, returning to FIG. 8, semantic labels associated with scenario 804 may be different from the semantic labels associated with scenario 814. For example, FIG. 9 includes an image 902 overlaid with semantic labeled regions 904 and bounding boxes 906. Bounding boxes 906 may be generated using unsupervised clustering and tracking.

In some aspects, aligner 618 may minimize the distance between perspective view and BEV predictions over HD map attributes. For example, aligner 618 may use subset 704 of source features 210 in semantic matching and/or in generating static masks. Aligner 618 may achieve KL divergence, for example, stochastic distance on the output tasks (e.g., output(s) 218 of machine-learning model(s) 216).

Returning to FIG. 7, selector 702 may, in general, identify subset 704 of source features 210 that are similar to target features 610. The similarity may be determined based on the features themselves (e.g., subset 704 of source features 210 and target features 610). Additionally or alternatively, the similarity may be determined based on the trajectory conditions, the surrounding-object conditions, and/or the environment under (and/or in) which the data on which the features are based was captured. In some cases, the similarity may be characterized by a distance (e.g., a stochastic distance) between subset 704 of source features 210 and target features 610. For example, 702 may measure the difference between source and target model output (e.g., output(s) 218 of machine-learning model(s) 216) in perspective view and BEV using HD map attributes (e.g., lanes, traffic lights, traffic signs) as ground truth supervision. In some cases, the target BEV and perspective-view tasks (e.g., machine-learning model(s) 216) may be fine-tuned to the HD map attributes when the semantic attribute distance and the dynamic trajectory distance are low (scenario is similar between source and target). In some cases, the similarity may be determined based on a Kullback-Leibler (KL) divergence stochastic loss measured between source and target BEV/PV task outputs.

In some cases, selector 702 may operate according to a number of criteria regarding and/or comparisons regarding the similarity. For example, in some cases, selector 702 may perform a comparison of the environments between target features 610 and source features 210 (e.g., as represented in target semantic attributes 720 and source semantic attributes 712 respectively). In such cases, selector 702 may filter out any source features 210 that do not satisfy an environment criteria. Additionally or alternatively, selector 702 may perform a comparison of the surrounding-object conditions (e.g., as represented by source object dynamics 710 and target object dynamics 718) and may filter out source features 210 based on satisfaction of a surrounding object criteria. Additionally or alternatively, selector 702 may compare trajectory conditions (as represented by source ego trajectory 708 and target ego trajectory 716) and filter out source features 210 based on satisfaction of a trajectory criteria.

In some aspects, selecting features may include generating positive masks and/or negative masks and masking sets of features to include and/or exclude features. For example, in such aspects, alignment may be performed when the trajectory conditions, the surrounding-object conditions, and/or the environment are similar to ensure aligned semantic/dynamic object domains. This may be achieved through matching positive/negative masks. For example, selector 702 may generate a positive mask for source features 210 corelated to source data for which source and target ego-trajectories are close semantically, environments are similar (e.g. urban areas), and dynamic object trajectories in segment have low distance. As another example, selector 702 may generate a negative mask for source features 210 corelated to source data for which source and target trajectories are semantically distant, with difference in classes (e.g. highway vs residential areas), and dynamic objects in the scene are very different between source and target (e.g., highway with high velocity vehicles in the case of the source data and intersection with slow pedestrians in the case of the target data).

The similarity between subset 704 of source features 210 and target features 610 may cause aligner 618 to generate training aligned features 624 in such a way that machine-learning model(s) 216 can process training aligned features 624 better than machine-learning model(s) 216 may process features aligned according to another technique. For example, aligner 706 generating training aligned features 624 based on subset 704 of source features 210 may cause training aligned features 624 to allow machine-learning model(s) 216 to perform better (e.g., more accurately) than if an alternative aligner generated aligned features based on all of source features 210.

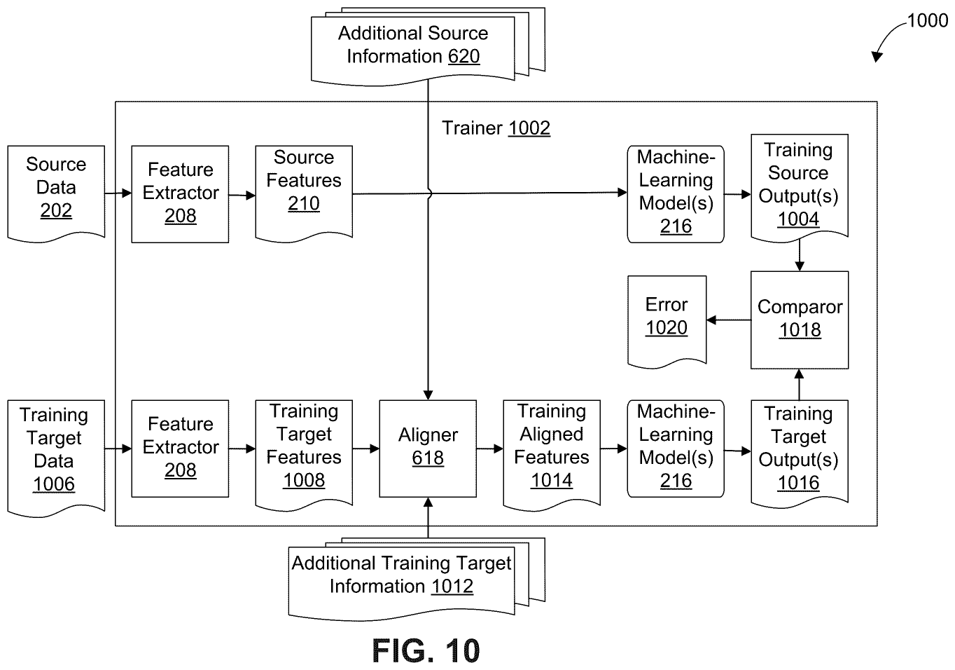

In some aspects, aligner 618 (including selector 702 and aligner 706) may be, or may include, one or more machine-learning models. For example, in some cases, aligner 618 may be trained in an end-to-end training process with machine-learning model(s) 216. In such cases, the selection of subset 704 of source features 210 may be based on a performance of machine-learning model(s) 216 which may be related to the similarity between subset 704 of source features 210 and target features 610. FIG. 10 provides an example of an end-to-end training process that may train aligner 618.

In cases in which aligner 618 includes one or more machine-learning models, aligner 618 may process target features 610, additional source information 620 (including source features 210, source ego trajectory 708, source object dynamics 710, source semantic attributes 712 and source sensor parameters 714), and additional target information 622 (including target ego trajectory 716, target object dynamics 718, target semantic attributes 720, target sensor parameters 722, and/or target location information 724) and generate training aligned features 624 as an output. Source sensor parameters 714 and target sensor parameters 722 may include indications of intrinsic and/or extrinsic parameters of source sensor suite 104 and target sensor suite 114, respectively. In cases in which aligner 618 includes one or more machine-learning models, the one or more machine-learning models may use source sensor parameters 714 and/or target sensor parameters 722 when generating training aligned features 624. Target location information 724 may be, or may include, information regarding a location of a target vehicle (e.g., target vehicle 112). Target location information 724 may be related to target features 610. For example, target location information 724 may include information indicative of where the target data on which target features 610 is based was captured. In some aspects, when the target data on which target features 610 is based is live (e.g., captured to be processed immediately), target location information 724 may also be live (e.g., captured concurrently with the target data).

FIG. 10 is a block diagram illustrating an example system 1000 that may be used to train aligner 618 and/or machine-learning model(s) 216, according to various aspects of the present disclosure. For example, system 1000 may include a trainer 1002. In general, trainer 1002 may receive training data (including source data 202, training target data 1006, additional source information 620, and additional target information 622) and use the training data to train aligner 618 and/or machine-learning model(s) 216 through an iterative process including comparing outputs to desired outputs. A goal of guided domain adaptation may be that machine-learning model(s) 216 generates substantially the same output based on source features 210 and training aligned features 624. Accordingly, trainer 1002 may train aligner 618 to generate training aligned features 1014 such that training target output(s) 1016 is substantially the same as training source output(s) 1004.

In some aspects, trainer 1002 may train machine-learning model(s) 216 to improve training source output(s) 1004 of machine-learning model(s) 216. For example, trainer 1002 may obtain source data 202, use feature extractor 208 to generates source features 210 based on source data 202, and provide source features 210 as inputs to machine-learning model(s) 216. Machine-learning model(s) 216 may generate training source output(s) 1004. Trainer 1002 may have criteria for the proper operation of machine-learning model(s) 216 and may analyze training source output(s) 1004 according to the criteria. Trainer 1002 may then adjust parameters (e.g., weights) of machine-learning model(s) 216 based on the operation as analyzed according to the criteria. In other cases, trainer 1002 may obtain machine-learning model(s) 216 fully-trained. In such cases, trainer 1002 may not further train machine-learning model(s) 216.

In any case, trainer 1002 may obtain training target data 1006, additional source information 620, and additional training target information 1012. Training target data 1006 may be data captured by a target sensor suite (e.g., target sensor suite 114 of FIG. 1). Additional training target information 1012 may be correlated to training target data 1006 in the same way, or substantially the same way that additional source information 620 is correlated to source features 210. Training target data 1006 and/or additional training target information 1012 may include a corpus of training data. Trainer 1002 may use feature extractor 208 to generate training target features 1008. The process of generating training target features 1008 based on training target data 1006 may be the same as, or substantially similar to, the process of generating source features 210 based on source data 202 as described with regard to FIG. 2 and FIG. 3. Aligner 618 may generate training aligned features 1014 based on training target features 1008, additional source information 620, and additional training target information 1012. The process of generating training aligned features 1014 based on training target features 1008, additional source information 620, and additional training target information 1012 may be the same as, or substantially similar to, the process of generating training aligned features 624 based on target features 610 as described with regard to FIG. 6 and FIG. 7. Machine-learning model(s) 216 may generate training target output(s) 1016 based on training aligned features 1014.

Comparer 1018 may compare training source output(s) 1004 to training target output(s) 1016 and determine error 1020. Error 1020 may be indicative of a difference between training source output(s) 1004 and training target output(s) 1016. Comparer 1018 may adjust parameters (e.g., weights) of aligner 618 to cause training target output(s) 1016 to be more similar to training source output(s) 1004 through iterations of training.

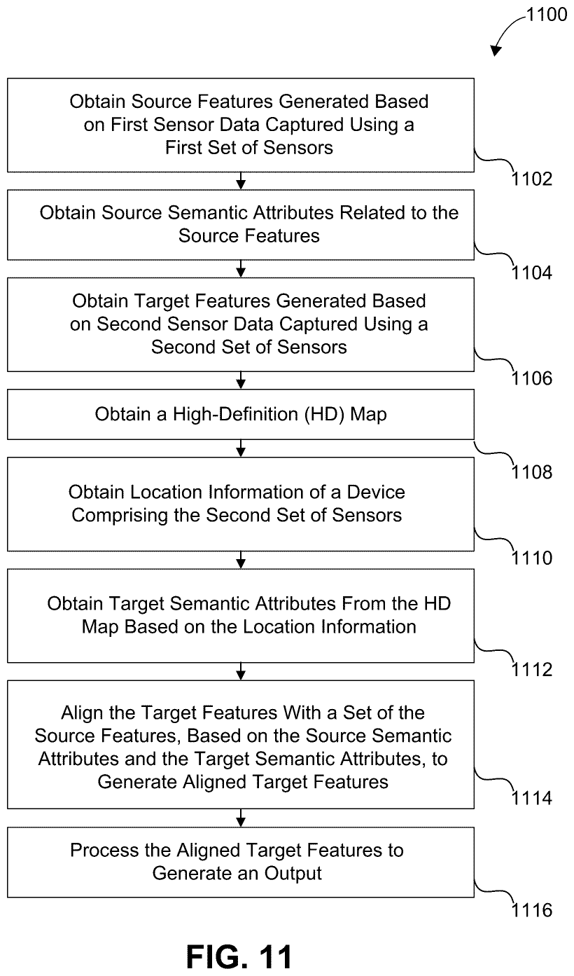

FIG. 11 is a flow diagram illustrating a process 1100 for performing guided domain adaptation, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1100. The one or more operations of process 1100 may be implemented as software components that are executed and run on one or more processors.

At a block 1102, a computing device (or one or more components thereof) may obtain source features generated based on first sensor data captured using a first set of sensors. For example, system 600 of FIG. 6 may obtain source features 210 (which may include fused top-down source features, fused perspective-view source features, and/or fused map-based features). Source features 210 may be generated based on first sensor data from a first set of sensors (e.g., of source sensor suite 104).

In some aspects, the source features may be, or may include, features generated by processing the first sensor data using a feature-extractor network trained to generate features based on data. For example, source features 210 may include source data 202 processed by feature extractor 208. In some aspects, the first sensor data may be, or may include, light detection and ranging (LIDAR) based point-cloud data and image data. The source features may be, or may include, top-down features and perspective-view features. For example, source data 202 may include LIDAR point cloud 204 and images 206, and source features 210 may include fused top-down features 314 and fused perspective-view features 432 based on source data 202. In some aspects, the source features may be, or may include, map-based features. For example, source features 210 may include map-based features 536 based on point map 534.

At a block 1104, the computing device (or one or more components thereof) may obtain source semantic attributes related to the source features. For example, system 600 may obtain additional source information 620, which may include source semantic attributes 712.

At a block 1106, the computing device (or one or more components thereof) may obtain target features generated based on second sensor data captured using a second set of sensors. For example, system 600 may obtain target features 610 (which may include fused top-down features 612, fused perspective-view features 614, and/or map-based features 616). Target features 610 may be based on second sensor data from a second set of sensors (e.g., target sensor suite 114).

In some aspects, the computing device (or one or more components thereof) may generate the target features by processing the second sensor data using a feature-extractor network trained to generate features based on data. For example, system 600 may process target data 602 using feature extractor 208 to generate target features 610. In some aspects, the second sensor data may be, or may include, light detection and ranging (LIDAR) based point-cloud data and image data. The target features may be, or may include, top-down features and perspective-view features. For example, target data 602 may include one or more LIDAR point clouds 604 and images 606. Target features 610 may include fused top-down features 612 and map-based features 616. In some aspects, the target features further may be, or may include, map-based features. For example, target features 610 may include map-based features 616.

In some aspects, extrinsic parameters and/or intrinsic parameters may be different between the first set of sensors and the second set of sensors. For example, the extrinsic and/or intrinsic parameters of source sensor suite 104 and target sensor suite 114 may be different. In some aspects, a count of the first set of sensors may be different than a count of the second set of sensors; a type of the first set of sensors may be different than a type of the second set of sensors; and/or relative positions of the first set of sensors may be different than relative positions of the second set of sensors. For example, source sensor suite 104 may include a different number of cameras 106 and/or LIDAR sensors 108 than target sensor suite 114 includes of cameras 116 and LIDAR sensors 118. Additionally or alternatively, source sensor suite 104 may include a different type of cameras 106 and/or LIDAR sensors 108 than target sensor suite 114 includes of cameras 116 and LIDAR sensors 118. Additionally or alternatively, source sensor suite 104 may include cameras 106 and/or LIDAR sensors 108 at different positions (relative to each other and/or relative to source vehicle 102) than target sensor suite 114 includes of cameras 116 and/or LIDAR sensors 118.

At a block 1108, the computing device (or one or more components thereof) may obtain a high-definition (HD) map. For example, system 600 may obtain point map 608.

At a block 1110, the computing device (or one or more components thereof) may obtain location information of a device comprising the second set of sensors. For example, system 600 may obtain additional target information 622 which may include target location information 724.

At a block 1112, the computing device (or one or more components thereof) may obtain target semantic attributes from the HD map based on the location information. For example, system 600 may obtain additional target information 622 which may include target semantic attributes 720.

At a block 1114, the computing device (or one or more components thereof) may align the target features with a set of the source features, based on the source semantic attributes and the target semantic attributes, to generate aligned target features. For example, aligner 618 may align target features 610 with subset 704 based on source semantic attributes 712 and target semantic attributes 720 to generate training aligned features 624. In some aspects, aligner 618 may select subset 704 based on source semantic attributes 712 and target semantic attributes 720 and determine training aligned features 624 based on target features 610 and subset 704.

In some aspects, the computing device (or one or more components thereof) may select the set of the source features based on a comparison of the source features and the target features. For example, selector 702 may select subset 704 of source features 210 based on source features 210 and target features 610 (e.g., based on a similarity between source features 210 and target features 610).

In some aspects, the computing device (or one or more components thereof) may select the set of the source features based on the source semantic attributes and the target semantic attributes. For example, selector 702 may select subset 704 of source features 210 based on source semantic attributes 712 and target semantic attributes 720 (e.g., based on a similarity between source semantic attributes 712 and target semantic attributes 720).

In some aspects, the computing device (or one or more components thereof) may obtain source ego-vehicle trajectory information related to the source features; obtain target ego-vehicle trajectory information of a device comprising the second set of sensors; and select the set of the source features based on the source ego-vehicle trajectory information and the target ego-vehicle trajectory information. For example, aligner 618 may obtain source ego trajectory 708 and target ego trajectory 716 and selector 702 may select subset 704 of source features 210 based on source ego trajectory 708 and target ego trajectory 716 (e.g., based on a similarity between source ego trajectory 708 and target ego trajectory 716).

In some aspects, the computing device (or one or more components thereof) may obtain source object trajectory information, wherein the source object trajectory information is indicative of first objects moving relative to the first set of sensors; obtain target object trajectory information, wherein the target object trajectory information is indicative of second objects moving relative to the second set of sensors; and select the set of the source features based on the source object trajectory information and the target object trajectory information. For example, aligner 618 may obtain source object dynamics 710 and target object dynamics 718. Source object dynamics 710 may include information regarding other objects moving relative to source vehicle 102 captured while source data on which source features 210 is based is captured. Target object dynamics 718 may include information regarding other objects moving relative to target vehicle 112 captured while target data on which target features 610 is based is captured. Selector 702 may select subset 704 of source features 210 based on source object dynamics 710 and target object dynamics 718 (e.g., based on a similarity between source object dynamics 710 and target object dynamics 718). In some aspects, the computing device (or one or more components thereof) may obtain sensor data representative of one or more other objects; and track the one or more other objects based on the sensor data to generate trajectory data for the one or more other objects. For example, target vehicle 112 may obtain sensor data (e.g., images and/or LIDAR point-cloud representations of other object around target vehicle 112, such as pedestrians or other vehicles). Target vehicle 112 may track the other objects to generate target object dynamics 718.

In some aspects, to align the target features, the computing device (or one or more components thereof) may process the target features and the set of the source features using a machine-learning model trained to generate aligned features based on first features and second features. For example, aligner 618 may include a aligner 706 that may include a trained machine-learning model. Aligner 706 may be trained to generate aligned target features based on target features and source features. In some aspects, to align the target features, the computing device (or one or more components thereof) may process source sensor parameters related to the source features and target sensor parameters related to the target features using the machine-learning model. For example, aligner 706 may take source sensor parameters 714 and target sensor parameters 722 as inputs when generating training aligned features 624.

At a block 1116, the computing device (or one or more components thereof) may process the aligned target features to generate an output. For example, machine-learning model(s) 216 may process training aligned features 624 (which may include aligned top-down features 626, aligned perspective-view features 628, and/or aligned map-based features 630) to generate output(s) 218.

In some aspects, to process the aligned target features, the computing device (or one or more components thereof) may provide the aligned target features to a machine-learning model trained to generate outputs based on features. The output may relate to at least one of: a three-dimensional lane detection; a three-dimensional object detection; a two-dimensional lane detection; or a two-dimensional object detection. For example, machine-learning model(s) 216 may perform three-dimensional lane detection, a three-dimensional object detection two-dimensional lane detection, or two-dimensional object detection.

In some aspects, the aligned target features may be processed using a machine-learning model trained using training source features based on training source data. For example, the aligned target features may be processed (e.g., at block 1116) using machine-learning model(s) 216. Machine-learning model(s) 216 may have been trained using source features 210. In some aspects, the training source data may be, or may include, the first sensor data. For example, the source features obtained at block 1102 (e.g., source features 210) may be based on at least part of the source data on which machine-learning model(s) 216 was trained. For example, source features 210 may be based on a corpus of training data. Machine-learning model(s) 216 may be trained on the corpus of training data. Source features 210 may be based on a subset of the corpus of training data.

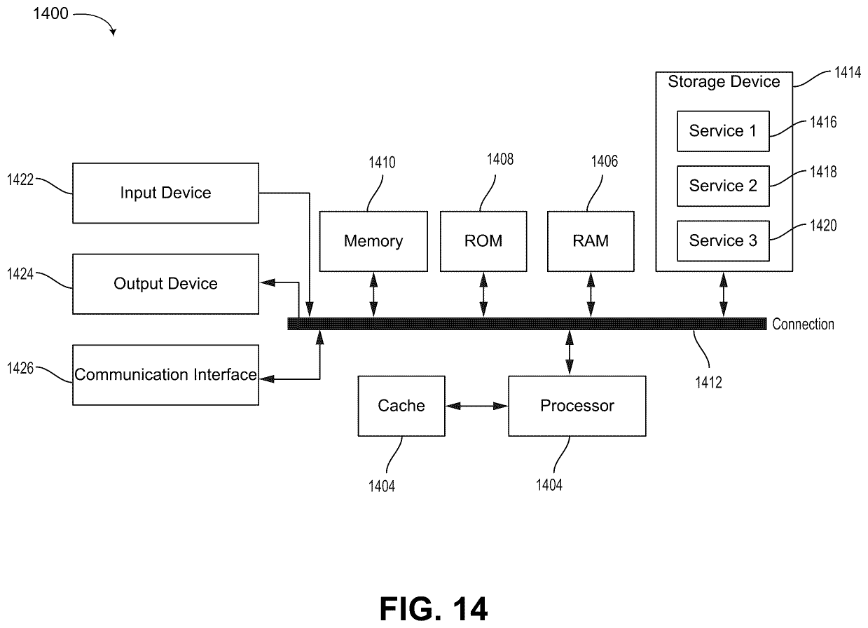

In some examples, as noted previously, the methods described herein (e.g., process 1100 of FIG. 11, and/or other methods described herein) can be performed, in whole or in part, by a computing device or apparatus. In one example, one or more of the methods can be performed by a computing system of target vehicle 112 of FIG. 1, system 600 of FIG. 6, aligner 618 of FIG. 6 and FIG. 7, system 700 of FIG. 7, or by another system or device. In another example, one or more of the methods (e.g., process 1100 of FIG. 11, and/or other methods described herein) can be performed, in whole or in part, by the computing-device architecture 1400 shown in FIG. 14. For instance, a computing device with the computing-device architecture 1400 shown in FIG. 14 can include, or be included in, the components of the computing system of target vehicle 112, system 600, aligner 618, and/or system 700, and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

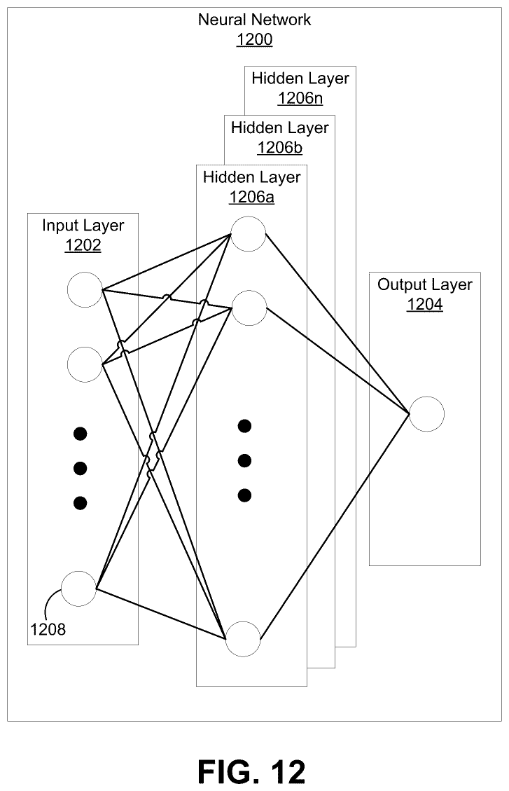

FIG. 12 is an illustrative example of a neural network 1200 (e.g., a deep-learning neural network) that can be used to implement machine-learning-based: object detection, lane detection, alignment, similarity determination, feature segmentation, implicit-neural-representation generation, rendering, classification, image recognition (e.g., face recognition, object recognition, scene recognition, etc.), feature extraction, authentication, gaze detection, gaze prediction, and/or automation. For example, neural network 1200 may be an example of, or can implement, feature extractor 208, machine-learning model(s) 216, feature extractor 304, flattener 308, fuser 312, feature extractor 318, projector 322, and/or aligner 618.

An input layer 1202 includes input data. In one illustrative example, input layer 1202 can include data representing source data 202, LIDAR point cloud 204, images 206, source features 210, LIDAR point cloud 302, 3D features 306, LIDAR top-down features 310, fused top-down features 314, images 316, perspective-view features 320, camera top-down features 324, fused perspective-view features 432, point map 534, map-based features 536, target data 602, LIDAR point cloud 604, images 606, point map 608, target features 610, fused top-down features 612, fused perspective-view features 614, fused map-based features 616, additional source information 620, additional target information 622, training aligned features 624, aligned top-down features 626, aligned perspective-view features 628, aligned map-based features 630, source ego trajectory 708, source object dynamics 710, source semantic attributes 712, source sensor parameters 714, target ego trajectory 716, target object dynamics 718, target semantic attributes 720, target sensor parameters 722, target location information 724, training target data 1006, training target features 1008, additional training target information 1012, training aligned features 1014, and/or training target output(s) 1016.

Neural network 1200 includes multiple hidden layers hidden layers 1206a, 1206b, through 1206n. The hidden layers 1206a, 1206b, through hidden layer 1206n include “n” number of hidden layers, where “n” is an integer greater than or equal to one. The number of hidden layers can be made to include as many layers as needed for the given application. Neural network 1200 further includes an output layer 1204 that provides an output resulting from the processing performed by the hidden layers 1206a, 1206b, through 1206n. In one illustrative example, output layer 1204 can provide source features 210, output(s) 218, 3D features 306, LIDAR top-down features 310, fused top-down features 314, perspective-view features 320, camera top-down features 324, fused perspective-view features 432, map-based features 536, target features 610, fused top-down features 612, fused perspective-view features 614, fused map-based features 616, training aligned features 624, aligned top-down features 626, aligned perspective-view features 628, aligned map-based features 630, training target features 1008, additional training target information 1012, training aligned features 1014, and/or training target output(s) 1016.

Neural network 1200 may be, or may include, a multi-layer neural network of interconnected nodes. Each node can represent a piece of information. Information associated with the nodes is shared among the different layers and each layer retains information as information is processed. In some cases, neural network 1200 can include a feed-forward network, in which case there are no feedback connections where outputs of the network are fed back into itself. In some cases, neural network 1200 can include a recurrent neural network, which can have loops that allow information to be carried across nodes while reading in input.

Information can be exchanged between nodes through node-to-node interconnections between the various layers. Nodes of input layer 1202 can activate a set of nodes in the first hidden layer 1206a. For example, as shown, each of the input nodes of input layer 1202 is connected to each of the nodes of the first hidden layer 1206a. The nodes of first hidden layer 1206a can transform the information of each input node by applying activation functions to the input node information. The information derived from the transformation can then be passed to and can activate the nodes of the next hidden layer 1206b, which can perform their own designated functions. Example functions include convolutional, up-sampling, data transformation, and/or any other suitable functions. The output of the hidden layer 1206b can then activate nodes of the next hidden layer, and so on. The output of the last hidden layer 1206n can activate one or more nodes of the output layer 1204, at which an output is provided. In some cases, while nodes (e.g., node 1208) in neural network 1200 are shown as having multiple output lines, a node has a single output and all lines shown as being output from a node represent the same output value.

In some cases, each node or interconnection between nodes can have a weight that is a set of parameters derived from the training of neural network 1200. Once neural network 1200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1200 to be adaptive to inputs and able to learn as more and more data is processed.

Neural network 1200 may be pre-trained to process the features from the data in the input layer 1202 using the different hidden layers 1206a, 1206b, through 1206n in order to provide the output through the output layer 1204. In an example in which neural network 1200 is used to identify features in images, neural network 1200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1200 is trained well enough so that the weights of the layers are accurately tuned.

For the example of identifying objects in images, the forward pass can include passing a training image through neural network 1200. The weights are initially randomized before neural network 1200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1200 can include any other deep network other than a CNN, such as an autoencoder, a deep belief nets (DBNs), a Recurrent Neural Networks (RNNs), among others.

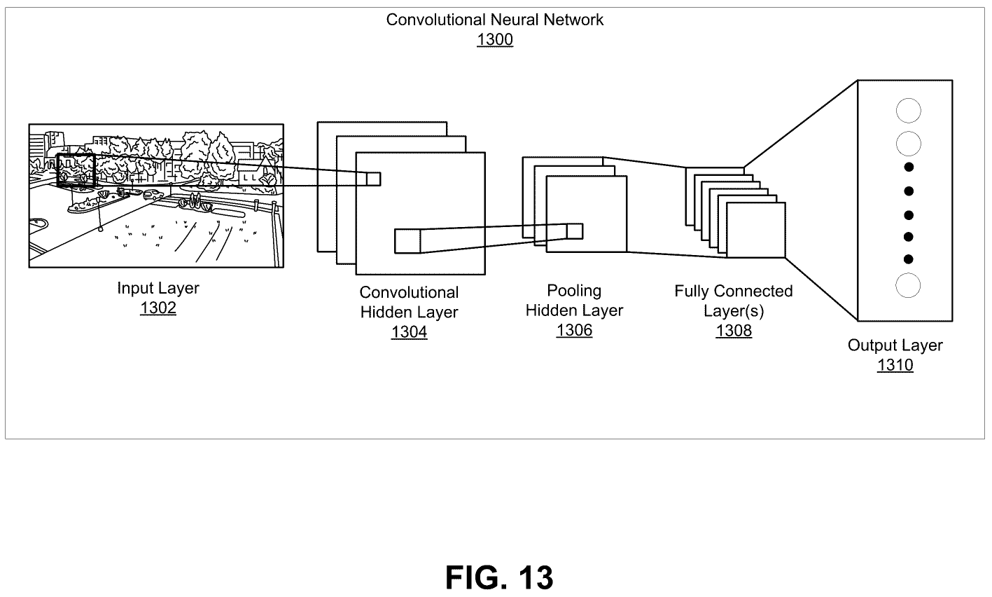

FIG. 13 is an illustrative example of a convolutional neural network (CNN) 1300. The input layer 1302 of the CNN 1300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1304, an optional non-linear activation layer, a pooling hidden layer 1306, and fully connected layer 1308 (which fully connected layer 1308 can be hidden) to get an output at the output layer 1310. While only one of each hidden layer is shown in FIG. 13, one of ordinary skill will appreciate that multiple convolutional hidden layers, non-linear layers, pooling hidden layers, and/or fully connected layers can be included in the CNN 1300. As previously described, the output can indicate a single class of an object or can include a probability of classes that best describe the object in the image.

The first layer of the CNN 1300 can be the convolutional hidden layer 1304. The convolutional hidden layer 1304 can analyze image data of the input layer 1302. Each node of the convolutional hidden layer 1304 is connected to a region of nodes (pixels) of the input image called a receptive field. The convolutional hidden layer 1304 can be considered as one or more filters (each filter corresponding to a different activation or feature map), with each convolutional iteration of a filter being a node or neuron of the convolutional hidden layer 1304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1304. Each connection between a node and a receptive field for that node learns a weight and, in some cases, an overall bias such that each node learns to analyze its particular local receptive field in the input image. Each node of the convolutional hidden layer 1304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1304 is due to each node of the convolutional layer being applied to its corresponding receptive field. For example, a filter of the convolutional hidden layer 1304 can begin in the top-left corner of the input image array and can convolve around the input image. As noted above, each convolutional iteration of the filter can be considered a node or neuron of the convolutional hidden layer 1304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1304.

The mapping from the input layer to the convolutional hidden layer 1304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1304 can include several activation maps in order to identify multiple features in an image. The example shown in FIG. 13 includes three activation maps. Using three activation maps, the convolutional hidden layer 1304 can detect three different kinds of features, with each feature being detectable across the entire image.

In some examples, a non-linear hidden layer can be applied after the convolutional hidden layer 1304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1300 without affecting the receptive fields of the convolutional hidden layer 1304.

The pooling hidden layer 1306 can be applied after the convolutional hidden layer 1304 (and after the non-linear hidden layer when used). The pooling hidden layer 1306 is used to simplify the information in the output from the convolutional hidden layer 1304. For example, the pooling hidden layer 1306 can take each activation map output from the convolutional hidden layer 1304 and generates a condensed activation map (or feature map) using a pooling function. Max-pooling is one example of a function performed by a pooling hidden layer. Other forms of pooling functions be used by the pooling hidden layer 1306, such as average pooling, L2-norm pooling, or other suitable pooling functions. A pooling function (e.g., a max-pooling filter, an L2-norm filter, or other suitable pooling filter) is applied to each activation map included in the convolutional hidden layer 1304. In the example shown in FIG. 13, three pooling filters are used for the three activation maps in the convolutional hidden layer 1304.

In some examples, max-pooling can be used by applying a max-pooling filter (e.g., having a size of 2×2) with a stride (e.g., equal to a dimension of the filter, such as a stride of 2) to an activation map output from the convolutional hidden layer 1304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1304 having a dimension of 24×24 nodes, the output from the pooling hidden layer 1306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1300.

The final layer of connections in the network is a fully-connected layer that connects every node from the pooling hidden layer 1306 to every one of the output nodes in the output layer 1310. Using the example above, the input layer includes 28×28 nodes encoding the pixel intensities of the input image, the convolutional hidden layer 1304 includes 3×24×24 hidden feature nodes based on application of a 5×5 local receptive field (for the filters) to three activation maps, and the pooling hidden layer 1306 includes a layer of 3×12×12 hidden feature nodes based on application of max-pooling filter to 2×2 regions across each of the three feature maps. Extending this example, the output layer 1310 can include ten output nodes. In such an example, every node of the 3×12×12 pooling hidden layer 1306 is connected to every node of the output layer 1310.

The fully connected layer 1308 can obtain the output of the previous pooling hidden layer 1306 (which should represent the activation maps of high-level features) and determines the features that most correlate to a particular class. For example, the fully connected layer 1308 can determine the high-level features that most strongly correlate to a particular class and can include weights (nodes) for the high-level features. A product can be computed between the weights of the fully connected layer 1308 and the pooling hidden layer 1306 to obtain probabilities for the different classes. For example, if the CNN 1300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1310 can include an M-dimensional vector (in the prior example, M=10). M indicates the number of classes that the CNN 1300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of system 200, feature extractor 208, machine-learning model(s) 216, system 300, feature extractor 304, flattener 308, fuser 312, feature extractor 318, projector 322, system 400, fuser 430, system 500, trainer 538, system 600, aligner 618, system 700, selector 702, aligner 706, system 1000, trainer 1002, and/or comparer 1018. Additionally or alternatively, computing-device architecture 1400 may be configured to perform process 1100, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing data; the apparatus comprising: at least one memory; and at least one processor coupled to the at least one memory and configured to: obtain source features generated based on first sensor data captured using a first set of sensors; obtain source semantic attributes related to the source features; obtain target features generated based on second sensor data captured using a second set of sensors; obtain map information; obtain location information of a device comprising the second set of sensors; obtain target semantic attributes from the map information based on the location information; align the target features with a set of the source features, based on the source semantic attributes and the target semantic attributes, to generate aligned target features; and process the aligned target features to generate an output.

Aspect 2. The apparatus of aspect 1, wherein at least one of extrinsic parameters or intrinsic parameters are different between the first set of sensors and the second set of sensors.

Aspect 3. The apparatus of any one of aspects 1 or 2, wherein at least one of: a count of the first set of sensors is different than a count of the second set of sensors; a type of the first set of sensors is different than a type of the second set of sensors; or relative positions of the first set of sensors are different than relative positions of the second set of sensors.

Aspect 4. The apparatus of any one of aspects 1 to 3, wherein the aligned target features are processed using a machine-learning model trained using training source features based on training source data.

Aspect 5. The apparatus of aspect 4, wherein the training source data comprises the first sensor data.

Aspect 6. The apparatus of any one of aspects 1 to 5, wherein, to align the target features, the at least one processor is configured to process the target features and the set of the source features using a machine-learning model trained to generate aligned features based on first features and second features.

Aspect 7. The apparatus of aspect 6, wherein, to align the target features, the at least one processor is further configured to processing source sensor parameters related to the source features and target sensor parameters related to the target features using the machine-learning model.

Aspect 8. The apparatus of any one of aspects 1 to 7, wherein the at least one processor is further configured to select the set of the source features based on a comparison of the source features and the target features.

Aspect 9. The apparatus of any one of aspects 1 to 8, wherein the at least one processor is further configured to select the set of the source features based on the source semantic attributes and the target semantic attributes.

Aspect 10. The apparatus of any one of aspects 1 to 9, wherein the at least one processor is further configured to: obtain source ego-vehicle trajectory information related to the source features; obtain target ego-vehicle trajectory information of a device comprising the second set of sensors; and select the set of the source features based on the source ego-vehicle trajectory information and the target ego-vehicle trajectory information.

Aspect 11. The apparatus of any one of aspects 1 to 10, wherein the at least one processor is further configured to: obtain source object trajectory information, wherein the source object trajectory information is indicative of first objects moving relative to the first set of sensors; obtain target object trajectory information, wherein the target object trajectory information is indicative of second objects moving relative to the second set of sensors; and select the set of the source features based on the source object trajectory information and the target object trajectory information.

Aspect 12. The apparatus of aspect 11, wherein the at least one processor is further configured to: obtain sensor data representative of one or more other objects; and track the one or more other objects based on the sensor data to generate trajectory data for the one or more other objects.

Aspect 13. The apparatus of any one of aspects 1 to 12, wherein, to obtain the target features, the at least one processor is configured to generate the target features by processing the second sensor data using a feature-extractor network trained to generate features based on data.

Aspect 14. The apparatus of aspect 13, wherein the second sensor data comprises light detection and ranging (LIDAR) based point-cloud data and image data, and wherein the target features comprise top-down features and perspective-view features.

Aspect 15. The apparatus of aspect 14, wherein the target features further comprise map-based features.

Aspect 16. The apparatus of any one of aspects 1 to 15, wherein the source features comprise features generated by processing the first sensor data using a feature-extractor network trained to generate features based on data.

Aspect 17. The apparatus of aspect 16, wherein the first sensor data comprises light detection and ranging (LIDAR) based point-cloud data and image data and wherein the source features comprise top-down features and perspective-view features.

Aspect 18. The apparatus of aspect 17, wherein the source features further comprise map-based features.

Aspect 19. The apparatus of any one of aspects 1 to 18, wherein, to process the aligned target features, the at least one processor is configured to provide the aligned target features to a machine-learning model trained to generate outputs based on features, and wherein the output relates to at least one of: a three-dimensional lane detection; a three-dimensional object detection; a two-dimensional lane detection; or a two-dimensional object detection.

Aspect 20. A method for processing data; the method comprising: obtaining source features generated based on first sensor data captured using a first set of sensors; obtaining source semantic attributes related to the source features; obtaining target features generated based on second sensor data captured using a second set of sensors; obtaining map information; obtaining location information of a device comprising the second set of sensors; obtaining target semantic attributes from the map information based on the location information; aligning the target features with a set of the source features, based on the source semantic attributes and the target semantic attributes, to generate aligned target features; and processing the aligned target features to generate an output.

Aspect 21. The method of aspect 20, wherein at least one of extrinsic parameters or intrinsic parameters are different between the first set of sensors and the second set of sensors.

Aspect 22. The method of any one of aspects 20 or 21, wherein at least one of: a count of the first set of sensors is different than a count of the second set of sensors; a type of the first set of sensors is different than a type of the second set of sensors; or relative positions of the first set of sensors are different than relative positions of the second set of sensors.

Aspect 23. The method of any one of aspects 20 to 22, wherein the aligned target features are processed using a machine-learning model trained using training source features based on training source data.

Aspect 24. The method of aspect 23, wherein the training source data comprises the first sensor data.

Aspect 25. The method of any one of aspects 20 to 24, wherein aligning the target features comprises processing the target features and the set of the source features using a machine-learning model trained to generate aligned features based on first features and second features.

Aspect 26. The method of aspect 25, wherein aligning the target features further comprises processing source sensor parameters related to the source features and target sensor parameters related to the target features using the machine-learning model.

Aspect 27. The method of any one of aspects 20 to 26, further comprising selecting the set of the source features based on a comparison of the source features and the target features.

Aspect 28. The method of any one of aspects 20 to 27, further comprising selecting the set of the source features based on the source semantic attributes and the target semantic attributes.

Aspect 29. The method of any one of aspects 20 to 28, further comprising: obtaining source ego-vehicle trajectory information related to the source features; obtaining target ego-vehicle trajectory information of a device comprising the second set of sensors; and selecting the set of the source features based on the source ego-vehicle trajectory information and the target ego-vehicle trajectory information.

Aspect 30. The method of any one of aspects 20 to 29, further comprising: obtaining source object trajectory information, wherein the source object trajectory information is indicative of first objects moving relative to the first set of sensors; obtaining target object trajectory information, wherein the target object trajectory information is indicative of second objects moving relative to the second set of sensors; and selecting the set of the source features based on the source object trajectory information and the target object trajectory information.

Aspect 31. The method of any one of aspects 20 to 30, further comprising: obtaining sensor data representative of one or more other objects; and tracking the one or more other objects based on the sensor data to generate trajectory data for the one or more other objects.

Aspect 32. The method of any one of aspects 20 to 31, wherein obtaining the target features comprises generating the target features by processing the second sensor data using a feature-extractor network trained to generate features based on data.

Aspect 33. The method of aspect 32, wherein the second sensor data comprises light detection and ranging (LIDAR) based point-cloud data and image data, and wherein the target features comprise top-down features and perspective-view features.

Aspect 34. The method of aspect 33, further comprising obtaining high-definition (HD) map data wherein the target features further comprise map-based features.

Aspect 35. The method of any one of aspects 20 to 34, wherein the source features comprise features generated by processing the first sensor data using a feature-extractor network trained to generate features based on data.

Aspect 36. The method of aspect 35, wherein the first sensor data comprises light detection and ranging (LIDAR) based point-cloud data and image data and wherein the source features comprise top-down features and perspective-view features.

Aspect 37. The method of aspect 36, wherein the source features further comprise map-based features.

Aspect 38. The method of any one of aspects 20 to 37, wherein processing the aligned target features comprises providing the aligned target features to a machine-learning model trained to generate outputs based on features, and wherein the output relates to at least one of: a three-dimensional lane detection; a three-dimensional object detection; a two-dimensional lane detection; or a two-dimensional object detection.

Aspect 39. A method for processing data; the method comprising: obtaining source features generated based on first sensor data captured using a first set of sensors; obtaining target features generated based on second sensor data captured using a second set of sensors; determining a subset of the source features based on additional information; aligning the target features with the subset of the source features to generate aligned target features; and processing the aligned target features to generate an output.

Aspect 40. The method of aspect 39, wherein selecting the subset of the source features is based on a comparison of the source features and the target features.

Aspect 41. The method of any one of aspects 39 or 40, further comprising: obtaining source semantic attributes related to the source features; and obtaining target semantic attributes; wherein selecting the subset of the source features is based on the source semantic attributes and the target semantic attributes.

Aspect 42. The method of aspect 41, wherein obtaining the target semantic attributes comprises: obtaining map information; obtaining location information of a device comprising the second set of sensors; and obtaining the target semantic attributes from the map information based on the location information.

Aspect 43. The method of any one of aspects 39 to 42, further comprising: obtaining source ego-vehicle trajectory information related to the source features; and obtaining target ego-vehicle trajectory information of a device comprising the second set of sensors; wherein selecting the subset of the source features is based on the source ego-vehicle trajectory information and the target ego-vehicle trajectory information.

Aspect 44. The method of any one of aspects 39 to 43, further comprising: obtaining source object trajectory information, wherein the source object trajectory information is indicative of first objects moving relative to the first set of sensors; and obtaining target object trajectory information, wherein the target object trajectory information is indicative of second objects moving relative to the second set of sensors; wherein selecting the subset of the source features is based on the source object trajectory information and the target object trajectory information.

Aspect 45. A non-transitory computer-readable storage medium having stored thereon instructions that, when executed by at least one processor, cause the at least one processor to perform operations according to any of aspects 20 to 44.

Aspect 46. An apparatus for providing virtual content for display, the apparatus comprising one or more means for perform operations according to any of aspects 20 to 44.

What is claimed is:

1. An apparatus for processing data; the apparatus comprising:
at least one memory; and
at least one processor coupled to the at least one memory and configured to:
obtain source features generated based on first sensor data captured using a first set of sensors;
obtain source semantic attributes related to the source features;
obtain target features generated based on second sensor data captured using a second set of sensors;
obtain map information;
obtain location information of a device comprising the second set of sensors;
obtain target semantic attributes from the map information based on the location information;
align the target features with a set of the source features, based on the source semantic attributes and the target semantic attributes, to generate aligned target features; and
process the aligned target features to generate an output.

2. The apparatus of claim 1, wherein at least one of extrinsic parameters or intrinsic parameters are different between the first set of sensors and the second set of sensors.

3. The apparatus of claim 1, wherein at least one of:
a count of the first set of sensors is different than a count of the second set of sensors;
a type of the first set of sensors is different than a type of the second set of sensors; or
relative positions of the first set of sensors are different than relative positions of the second set of sensors.

4. The apparatus of claim 1, wherein the aligned target features are processed using a machine-learning model trained using training source features based on training source data.

5. The apparatus of claim 4, wherein the training source data comprises the first sensor data.

6. The apparatus of claim 1, wherein, to align the target features, the at least one processor is configured to process the target features and the set of the source features using a machine-learning model trained to generate aligned features based on first features and second features.

7. The apparatus of claim 6, wherein, to align the target features, the at least one processor is further configured to processing source sensor parameters related to the source features and target sensor parameters related to the target features using the machine-learning model.

8. The apparatus of claim 1, wherein the at least one processor is further configured to select the set of the source features based on a comparison of the source features and the target features.

9. The apparatus of claim 1, wherein the at least one processor is further configured to select the set of the source features based on the source semantic attributes and the target semantic attributes.

10. The apparatus of claim 1, wherein the at least one processor is further configured to:
obtain source ego-vehicle trajectory information related to the source features;
obtain target ego-vehicle trajectory information of a device comprising the second set of sensors; and
select the set of the source features based on the source ego-vehicle trajectory information and the target ego-vehicle trajectory information.

11. The apparatus of claim 1, wherein the at least one processor is further configured to:
obtain source object trajectory information, wherein the source object trajectory information is indicative of first objects moving relative to the first set of sensors;
obtain target object trajectory information, wherein the target object trajectory information is indicative of second objects moving relative to the second set of sensors; and
select the set of the source features based on the source object trajectory information and the target object trajectory information.

12. The apparatus of claim 11, wherein the at least one processor is further configured to:
obtain sensor data representative of one or more other objects; and
track the one or more other objects based on the sensor data to generate trajectory data for the one or more other objects.

13. The apparatus of claim 1, wherein, to obtain the target features, the at least one processor is configured to generate the target features by processing the second sensor data using a feature-extractor network trained to generate features based on data.

14. The apparatus of claim 13, wherein the second sensor data comprises light detection and ranging (LIDAR) based point-cloud data and image data, and wherein the target features comprise top-down features and perspective-view features.

15. The apparatus of claim 14, wherein the target features further comprise map-based features.

16. The apparatus of claim 1, wherein the source features comprise features generated by processing the first sensor data using a feature-extractor network trained to generate features based on data.

17. The apparatus of claim 16, wherein the first sensor data comprises light detection and ranging (LIDAR) based point-cloud data and image data and wherein the source features comprise top-down features and perspective-view features.

18. The apparatus of claim 17, wherein the source features further comprise map-based features.

19. The apparatus of claim 1, wherein, to process the aligned target features, the at least one processor is configured to provide the aligned target features to a machine-learning model trained to generate outputs based on features, and wherein the output relates to at least one of:
a three-dimensional lane detection;
a three-dimensional object detection;
a two-dimensional lane detection; or
a two-dimensional object detection.

20. A method for processing data; the method comprising:
obtaining source features generated based on first sensor data captured using a first set of sensors;
obtaining source semantic attributes related to the source features;
obtaining target features generated based on second sensor data captured using a second set of sensors;
obtaining map information;
obtaining location information of a device comprising the second set of sensors;
obtaining target semantic attributes from the map information based on the location information;
aligning the target features with a set of the source features, based on the source semantic attributes and the target semantic attributes, to generate aligned target features; and
processing the aligned target features to generate an output.

21. The method of claim 20, wherein at least one of extrinsic parameters or intrinsic parameters are different between the first set of sensors and the second set of sensors.

22. The method of claim 20, wherein at least one of:
a count of the first set of sensors is different than a count of the second set of sensors;
a type of the first set of sensors is different than a type of the second set of sensors; or
relative positions of the first set of sensors are different than relative positions of the second set of sensors.

23. The method of claim 20, wherein the aligned target features are processed using a machine-learning model trained using training source features based on training source data.

24. The method of claim 23, wherein the training source data comprises the first sensor data.

25. The method of claim 20, wherein aligning the target features comprises processing the target features and the set of the source features using a machine-learning model trained to generate aligned features based on first features and second features.

26. The method of claim 25, wherein aligning the target features further comprises processing source sensor parameters related to the source features and target sensor parameters related to the target features using the machine-learning model.

27. The method of claim 20, further comprising selecting the set of the source features based on a comparison of the source features and the target features.

28. The method of claim 20, further comprising selecting the set of the source features based on the source semantic attributes and the target semantic attributes.

29. The method of claim 20, further comprising:
obtaining source ego-vehicle trajectory information related to the source features;
obtaining target ego-vehicle trajectory information of a device comprising the second set of sensors; and
selecting the set of the source features based on the source ego-vehicle trajectory information and the target ego-vehicle trajectory information.

30. The method of claim 20, further comprising:
obtaining source object trajectory information, wherein the source object trajectory information is indicative of first objects moving relative to the first set of sensors;
obtaining target object trajectory information, wherein the target object trajectory information is indicative of second objects moving relative to the second set of sensors; and
selecting the set of the source features based on the source object trajectory information and the target object trajectory information.
